(19) United States
(12) Patent Application Publication
(10) Pub. No.: US 2014/0185293 A1
(43) Pub. Date: Jul. 3, 2014

(54) INTERCHANGEABLE MOLDING DESIGNS AND LIGHTING PANELS

(71) Applicants: Michael Ayotte, Murray, UT (US); Andrew Walker, Sandy, UT (US)

(72) Inventors: Michael Ayotte, Murray, UT (US); Andrew Walker, Sandy, UT (US)

(21) Appl. No.: 13/965,489

(22) Filed: Aug. 13, 2013

Related U.S. Application Data
(63) Continuation-in-part of application No. 13/733,479, filed on Jan. 3, 2013.

(51) Int. Cl. F21S 8/02; E04F 19/02

(52) U.S. Cl. CPC F21S 8/02; E04F 19/02
USPC 362/249.02; 362/249.01; 362/249.14

(57) ABSTRACT

A molding member may include at least one interchangeable panel that may be interchanged after the molding member has been installed to a support structure. The molding member may allow the molding design to be replaced to match the desired appearance of the room in which the molding is attached. Thus, the molding design may be interchanged without having to remove and reinstall new molding members. The molding design may include interchangeable lighting elements.

### CROSS-REFERENCE TO RELATED APPLICATIONS

This application is a continuation-in-part of co-pending U.S. Patent Application Ser. No. 13/733,479, filed Jan. 3, 2013 and entitled “Interchangeable Molding Designs,” the disclosure of which is hereby incorporated herein by reference in its entirety.

### FIELD

This disclosure relates generally to various types of molding adapted with insertable, interchangeable design panels that may be removed and replaced after the molding has been attached to a wall or other support structure. In some embodiments, the interchangeable design panels may include or be associated with at least one interchangeable lighting panel.

### BACKGROUND

Base molding, trim molding, crown molding, or other types of molding are often installed only once during the life of a building. Once molding is installed, it is difficult to alter the molding design without removing the entire piece of molding. Although carpet or wall colors in a room may change, the molding typically remains the same design, unless the entire molding is removed and a new molding design is installed.

### BRIEF SUMMARY

It is desirable to have decorative molding with interchangeable panel designs so that when the various aspects, designs, or uses of a room change, design panels within the existing molding may be changed without having to replace the molding. In the installed position, the ends of the molding may not be accessible, which may preclude sliding a new design panel or lighting panel into position. However, the molding may be designed to allow the design panels to be removable from within the molding after the molding has been attached to a support structure without having to remove the molding from the support structure. The ability to alter the design of the molding with interchangeable designs and lights without reinstalling new molding members to a support structure may be advantageous in changing the overall decorative appearance of a room and molding pattern.

In one embodiment, a molding member may include a body member adapted to be attached to a structure such as a wall, ceiling, or floor. A removable design panel may be at least partially disposed within the body member. The removable design panel may be interchangeable after the body member is attached to the structure to which it is adapted to be attached. At least one removable lighting panel may be disposed within the body member.

In another embodiment, a molding member may include a body member adapted to be attached to a structure such as a wall, ceiling, or floor. The body member may partially enclose a cavity. A cross-section of the cavity may be defined by a trapezoidal shape. At least one removable lighting panel may be at least partially disposed within the cavity. The at least one removable lighting panel may be interchangeable from within the cavity after the body member is attached to the structure to which the body member is adapted to be attached to.

In yet another embodiment, a molding member may include a body member defining a cavity. The cavity may be defined by a top surface, a top retaining ledge, a bottom retaining ledge, a bottom surface, and a back surface. The body member may include at least one removable panel at least partially disposed between the top surface and the bottom surface. The at least one removable panel may be removable after the body member is mounted to a support structure. The body member may include at least one lighting panel at least partially disposed between the top surface and the bottom surface of the cavity.

### BRIEF DESCRIPTION OF THE DRAWINGS

While the specification concludes with claims particularly pointing out and distinctly claiming what are regarded as embodiments of the disclosure, various features and advantages of this disclosure may be more readily ascertained from the following description of example embodiments provided with reference to the accompanying drawings, in which:

FIG. 1 is a schematic cross-section of one embodiment of a molding member adapted and configured to accept interchangeable panel members;

FIG. 2 is a cross-section of one embodiment of a design panel member;

FIG. 3 is a cross-section of one embodiment of a front panel member;

FIG. 4 is a schematic cross-section of one embodiment of a molding member;

FIG. 5a though 5e are depictions of the installation process of a design panel member and a front panel member;

FIG. 6 is a schematic cross-section of another embodiment of a molding member;

FIG. 7 is a schematic cross-section of an embodiment of a molding member including a top recess and a bottom recess, each partially defined by a curved surface;

FIG. 8 is a schematic cross-section of an embodiment of a molding member including an adhesive material;

FIG. 9 is a schematic of an elongated molding member; and

FIG. 10 is a schematic of a continuous molding design with an enclosed pattern.

### DETAILED DESCRIPTION

Disclosed herein is an improved molding design for easy installation and removal of various molding design insert panels and lighting panels without the need to remove the molding member. After installation of the molding, the design panels and lighting panels of the molding may be interchanged without removing the molding from the support structure to which it is attached. The molding may be useful as a crown molding, a window or door molding, base molding, or as a molding associated with a picture frame, painting, vanity display, mirror etc.

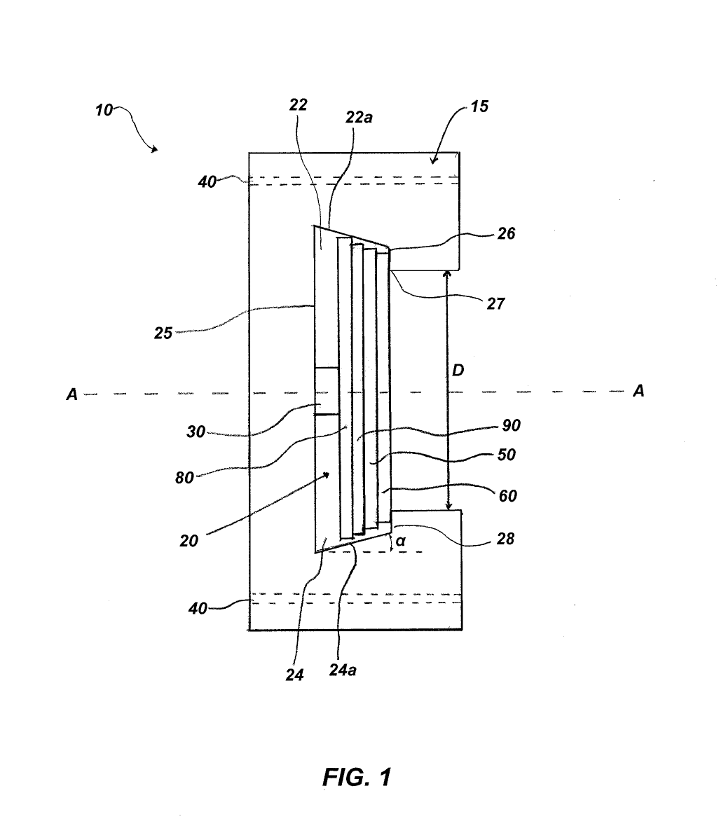

A schematic cross-section of a molding 10 with interchangeable design panels and interchangeable lighting panels 90 is shown in FIG. 1. The molding 10 may include a body member 15 that may be adapted to be attached to a support structure, such as, for example, a wall, ceiling, or floor. The molding 10 may be elongated and substantially linear. The body member 15 may be attached to a support structure by fastening means 40. Fastening means 40 may include nails, screws, glue, or any other fastening means to attach the body member 15 to a support structure. The body member 15 may be designed such that the body member 15 may be retrofitted with various types of interchangeable panels, such as interchangeable design panels 50, optional front panels 60, an optional back panel 80, and lighting panels 90 after the body member 15 has been attached to a support structure. In FIG. 1, although the lighting panel 90 is shown behind the design panel 50, the lighting panel 90 may be located in front of the design panel 50. In one embodiment, the molding 10 may not include the design panel 50 and may include only a lighting panel 90.

The body member 15 may be generally symmetrical about axis A-A. Axis A-A may be substantially perpendicular to the support structure to which the molding 10 is attached. In another embodiment, the axis A-A may be angled with respect to the support structure to which the molding 10 is attached, such as in crown molding. The body member 15 may define a display cavity 20 in which interchangeable design panel 50, front panel 60, back panel 80, and lighting panel 90 may be installed. In one embodiment, at least one lighting panel 90 may be installed within the cavity 20. An optional back panel 80 may also be installed within the display cavity 20. In one embodiment, the display cavity 20 may be defined by a trapezoidal shape and may include a top recess 22 and a bottom recess 24. The top recess 22 and the bottom recess 24 may be sized and configured to accept and retain the interchangeable design panel 50, the front panel 60, the back panel 80 and the lighting panel 90. Such panels may be sized to have heights adapted to fit within the space between the top recess 22 and the bottom recess 24. In one embodiment, the cross-section of the display cavity 20 may be shaped as an isosceles trapezoid. In such an embodiment, walls defining the top recess 22 and the bottom recess 24 may have substantially the same length. The top recess 22 and the bottom recess 24 may be substantially continuous and planar, as shown in FIG. 1.

The design cavity 20 may be structured to allow easy installation of the various panels after the body member 15 has been attached to a support structure. The display cavity 20 may be partially defined by a top retaining ledge 26 and a bottom retaining ledge 28 to retain the various panels within the display cavity 20. In some embodiments, the top retaining ledge 26 may include at least one surface that is coplanar with at least one surface of the bottom retaining ledge 28. The top retaining ledge 26 and the bottom retaining ledge 28 may include at least one surface that is substantially perpendicular to axis A-A. Each of the top retaining ledge 26 and the bottom retaining ledge 28 may include a corner 27. In one embodiment, at least one corner 27 of the top retaining ledge 26 and the bottom retaining ledge 28 may be rounded or beveled. In another embodiment, the corners 27 of the top retaining ledge 26 and the bottom retaining ledge may be substantially square, as shown in FIG. 1.

With continued reference to FIG. 1, the display cavity 20 may include an opening defined by the shortest distance between the top retaining ledge 26 and the bottom retaining ledge 28 (generally designated as dimension D). The display cavity 20 may be defined by a back wall 25, a top surface 22a, a bottom surface 24a, the top retaining ledge 26, and the bottom retaining ledge 28. In some embodiments, the back wall 25 may have a length that is larger than distance D. In other embodiments, the back wall 25 may have a length that is substantially the same as distance D. The back wall 25 may include a substantially continuous and substantially flat surface. The back wall 25 may include a surface that is substantially parallel with at least one surface of the top retaining ledge 26 and at least one surface of the bottom retaining ledge 28.

The top recess 22 and the bottom recess 24 may be designed to retain the design panel 50, the front panel 60, the back panel 80, and the lighting panel 90 within the display cavity 20. The top recess 22 may be defined by a top portion of the back wall 25, the top surface 22a, and the top retaining ledge 26. The bottom recess 24 may be defined by a bottom portion of the back wall 25, the bottom surface 24a, and the bottom retaining ledge 28. The top surface 22a and the bottom surface 24a may have substantially the same length. Top surface 22a and bottom surface 24a may create an angle α with axis A-A. Angle α may vary, such as for example, between approximately 10° and 20°. In one embodiment, angle α may be approximately 14°. In one embodiment, angle α between axis A-A and the top surface 22a may be substantially the same as angle α between axis A-A and the bottom surface 24a. In one embodiment, the top half of body member 15 may be a mirror image of the bottom half of the body member 15. In yet another embodiment, the angle between the top surface 22a and axis A-A may not be the same as the angle between the bottom surface 24a and axis A-A.

In one embodiment, the back wall 25 may include a plurality of snap receptacles. Thus, the back wall 25 may be configured to receive a design panel 50, a lighting panel 90, or a back panel 80 with snaps to be engaged by the snap receptacles of the back wall 25. In another embodiment, the back wall 25 may include a hook-and-loop fastener (e.g., VELCRO®) or a magnetic fastener. The interchangeable design panel 50, lighting panel 90, or the back panel 80 may include a corresponding fastener. In yet another embodiment, the back wall 25 may include an adhesive material such as a removable double-sided tape material or a glue material. The adhesive material may attach the interchangeable design panel 50, lighting panel 90, or the back panel 80 to the back wall 25.

In one embodiment, a compressible material 30 may be attached to the back wall 25. The compressible material 30 may comprise a sponge-like material, a foam material, a double-sided tape material, or a weather-strip material. In one embodiment, the compressible material 30 may be a weather-strip material. In another embodiment, the compressible material may be a closed cell foam material. The compressible material 30 may be sufficiently compressible to compress along axis A-A. When the compressible material 30 is compressed, space along axis A-A within the display cavity 20 may be created for installation or removal of the front panel 60, the design panel 50, the lighting panel 90, and the back panel 80. Once the desired panels are installed, the compressible material 30 may expand and push the installed panels against the top retaining ledge 26 and the bottom retaining ledge 28. The expansion of the compressible material 30 may cause the interchangeable panels to be flush against the retaining ledges and may prevent the interchangeable panels from shifting within the display cavity 20. The compressible material 30 may have a length that is substantially less than the length of the back wall 25, as shown in FIG. 1. Thus, in some embodiments, the compressible material 30 may not abut the top surface 22a or the bottom surface 24a.

The design panel 50 may include various designs and materials. The design panel 50 may include a designed or engraved wood panel, a panel comprising a leather material, a glow in the dark material, a glass or stained glass material, a plastic material, or a tile material, such as, for example, a ceramic tile, glass tile, or marble tile. The design panel 50 may be substantially flat, or it may include a textured surface. The design panel 50 may include a substantially rigid material or may include a substantially flexible material. In one embodiment, the design panel 50 may have a thickness extending from the back wall 25 outwardly past the retaining ledges and beyond the front face of the body member 15. In another embodiment, the design panel 50 may have a minimal thickness, such as, for example, the thickness of paper, cloth, or wallpaper. In yet another embodiment, the design panel 50 may have a thickness of between about ⅛″ and about ⅜″. In another embodiment, the thickness of the design panel 50 may be between about ⅜″ to about ⅞″. In yet another embodiment, the thickness of the design panel 50 may be greater than ⅞″.

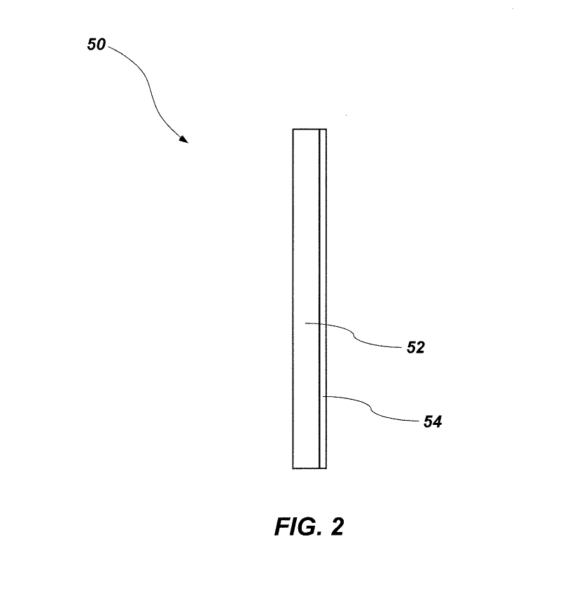

Referring to FIG. 2, the design panel 50 may include a support backing structure 52 and a design material 54. The support backing structure 52 may include a rigid material such as a rigid plastic, wood, or metal material. In one embodiment, the support backing structure 52 may include particle board, plywood, or other wood material support. In another embodiment, the support backing structure 52 may include flexible material, such as a compressible sponge-like or foam material. In one embodiment, the support backing structure may include a closed cell foam material. The design material 54 may be attached to the support backing structure 52 by any attachment means, such as, for example, glue, a thin double-sided tape, or any other suitable adhesive material. In another embodiment, the design material 54 may be stitched or sewed to the support backing structure 52.

The design material 54 may include any material, such as a wallpaper material, a leather material, a cloth material, or a glow in the dark type material attached to the support backing structure 52. Where the design material 54 is a wallpaper material, the design material 54 may be commercially available with an adhesive material on the back side thereof. In such embodiments, the design material 54 may be easily attached to the support backing structure 52.

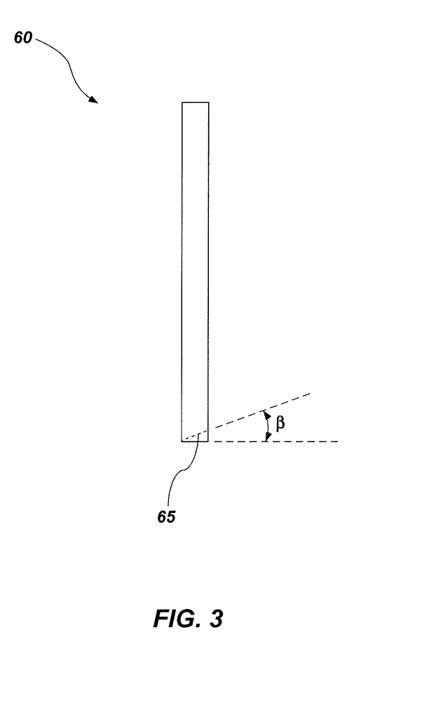

Each of the front panel 60 and the back panel 80 may comprise a transparent material, such as, for example, a plexiglass material, a thin plastic material, or other transparent material. Referring to FIG. 3, the front panel 60 may have a tapered edge 65. In embodiments in which the front panel 60 includes a tapered edge 65, an angle β formed between the tapered edge 65 and axis A-A may be between about 10° and 20°. In one embodiment, the angle β is approximately 17°. In another embodiment, the front panel 60 may not include a tapered edge 65 and the cross-section of the front panel 60 may be substantially rectangular in shape. The back panel 80 may be substantially similar in design, shape, and material as the front panel 60.

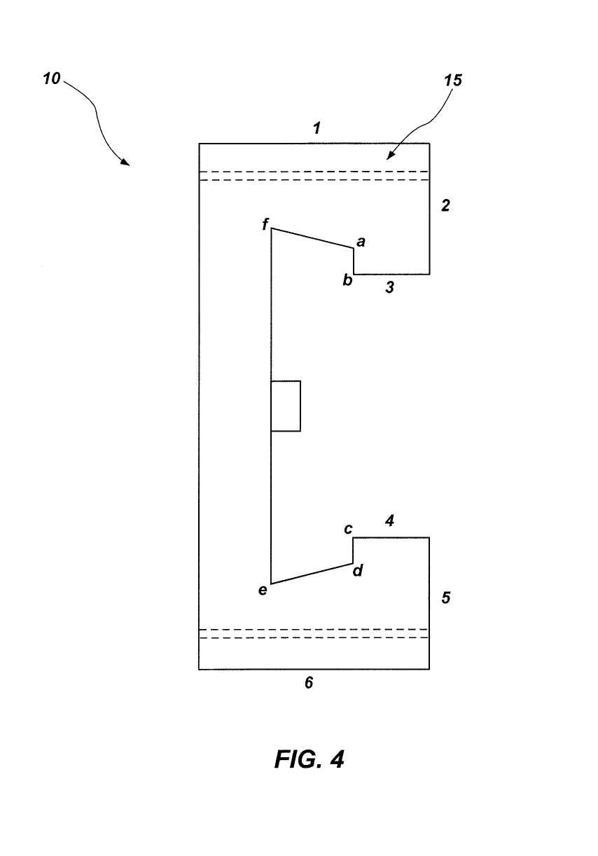

The molding 10 may include at least one lighting panel 90 located anywhere within the display cavity 20 or attached to any surface of the body member 15. In one embodiment, the lighting panel 90 may be affixed to any of surfaces 1 through 6 (FIG. 4) of the body member 15 rather than within the display cavity 20. In one embodiment, the lighting panel 90 is disposed within the display cavity 20. The lighting panel 90 may be in front of or behind the design panel 50. In one embodiment, at least one lighting panel 90 is in front of the design panel 50 and at least one lighting panel 90 is behind the design panel 50. In another embodiment, at least one lighting panel 90 is disposed within the cavity 20 and at least another lighting panel 90 is attached to a surface of the body member 15. In another embodiment, the lighting panel 90 may be attached to the design panel 50.

The lighting panel 90 may take various forms. In one embodiment, the lighting panel 90 may include a flexible bar, strip, panel, or ribbon including lights such as light-emitting diode (LED) lights. For example, the lighting panel 90 may include a plurality of LED bars, LED strips, LED panels, or LED ribbons that may be electrically interconnected in series or parallel. The lighting panel 90 may be substantially rigid or the lighting panel 90 may be substantially flexible.

The lighting panel 90 may be electrically connected to the power supply of a building via an electric power converter. The electric power converter may be a transformer or adaptor and may adjust the voltage to the lighting panel 90. The electrical connections of the lighting panel 90 may be disposed and hidden from view within internal portions of the body member 15. In one embodiment, the electrical connections are disposed within the cavity 20 of the body member. In one embodiment, the electrical connections are disposed at a corner where a first section of molding 10 meets another section of molding 10. In yet another embodiment, an electric power converter may be disposed within walls of a building and wires from the power converter may be connected to the lighting panel 90 via the back wall 25.

In one embodiment, the lighting panel may be electrically connected to a back-up power supply system, such as a 12V battery supply. The back-up power supply may be used in events such as power failures. The lighting panels 90 may provide an emergency lighting system with a low power consumption. In some embodiments, the lighting panel 90 may be coupled to the power supply of a building and may also be coupled to the redundant power supply. Such installations may be useful in hospitals or other emergency situations where low power consumption lighting is required in the event of a power failure. Thus, the lighting panel 90 may include LED lights with a low power input and low power requirement.

The lighting panel 90 may include a plurality of lighting panels of various light outputs and wavelengths. The lighting panel 90 may include a variety of light colors and light intensities. In one embodiment, the light intensity of each color may be individually adjusted to create a lighting display with a plurality of colors and light intensities for each color. By way of non-limiting example, the lighting panel 90 may include blue lights and red lights, each with the ability to be dimmed or brightened individually. The lighting panel 90 may be programmable with various flashing, blinking, and lighting designs. By way of non-limiting example, in one embodiment, the lighting panel 90 may be adapted to flash in rhythm with music.

The lighting panel 90 may be coupled to a controller. The controller may include a dimmer, a lux meter, an on/off switch coupled to each of a motion sensor and a sound meter, and a timer. The timer may be programmed to turn the lighting panel 90 on or off at predetermined times of the day. In one embodiment, the lighting panel 90 may be adapted and configured to communicate with a remote controller to power the lighting element 90 on and off. The remote control may control various features of the lighting panel 90 such as, for example, the light intensity and the light colors.

The lighting panel 90 may be coupled to a dimmer switch to adjust the light output of the lighting panel 90. The dimmer switch may be manually controlled or it may be coupled to a controller. The dimmer switch may control the intensity of individual colors on the lighting panel 90. In one embodiment, a dimmer switch may be coupled to a lux meter or any device capable of measuring light intensity or illuminance. The dimmer may be in communication with the lux meter and the intensity of the lighting panel 90 may be adjusted depending on the light intensity of the surrounding environment. Thus, the dimmer may be adjusted by the lux meter to control the light output based on the intensity of the ambient light. The brightness of the lighting panel 90 may be adjusted either upward or downward depending on the light intensity of the surrounding environment. In another embodiment, the dimmer switch may be coupled to a controller to adjust the light output depending on the time of day.

In another embodiment, the lighting panel 90 may be coupled to a motion sensor. When activated, the motion sensor may send a signal to a switch to activate the lighting panel 90. If the lighting panel 90 is activated by motion, the lighting panel 90 may be programmed to deactivate after a predetermined time passes without detection of further motion. The motion sensor may be located near an entry to the room decorated with the molding 10. In one embodiment, the motion sensor may have a lens with a wide field of view and may be activated by movement from anywhere within a room containing the motion sensor.

In another embodiment, the lighting panel 90 may be coupled to a sound detector. Activation of the sound detector may send a signal to a switch to activate the lighting panel 90. The lighting panel 90 may be programmed to deactivate if a predetermined time passes after the lighting panel 90 has been activated by the sound detector without the detection of further sound.

In one embodiment, the front panel 60, the lighting panel 90, the design panel 50, and the back panel 80 may include a substantially rigid material. The particular design of the body member 15 with the top recess 22 and the bottom recess 24 may allow for installation and removal of the interchangeable panels without having to flex or alter the shape of the interchangeable panels upon installation or removal of such panels.

Referring to FIG. 4, the general dimensions of the body member 15 are shown. The body member 15 includes exterior surfaces 1 through 6, which may include various designs and engravings. Each of the the front panel 60, the design panel 50, the lighting panel 90, and the back panel 65 may be designed with a length greater than the distance between points a and c, or the distance between points b and d. Thus, each of the panels may have a length that is greater than the sum of the length of at least one of the retaining ledges and the shortest distance between such ledges. In another embodiment, the panels may have a length up to approximately the length of the distance between points f and c, or the distance between points e and b. In some embodiments, the foremost portion of either the front panel 60, the design panel 50, or the lighting panel 90 abuts the retaining ledges and may not fall out from within the display cavity 20. In this manner, once the panels are installed within the display cavity 20 of the body member 15, the panels may be retained and secured within the display cavity 20 by the top retaining ledge 26 and the bottom retaining ledge 28.

Each of the panels and the display cavity 20 may be designed such that the panels may be easily installed and removed from within the display cavity 20. The panels may be slidable within the recesses of the display cavity 20 and may be slidably installed in the body member 15. However, once the body member 15 is mounted to a supporting wall structure, the interchangeable panels may not be as easily slidably installed or removed. However, as described below, the design of the body member 15 may allow for the interchangeable panels to be installed or removed after the body member 15 has been affixed to a supporting wall structure by interchanging such panels from a front face of the body member 15.

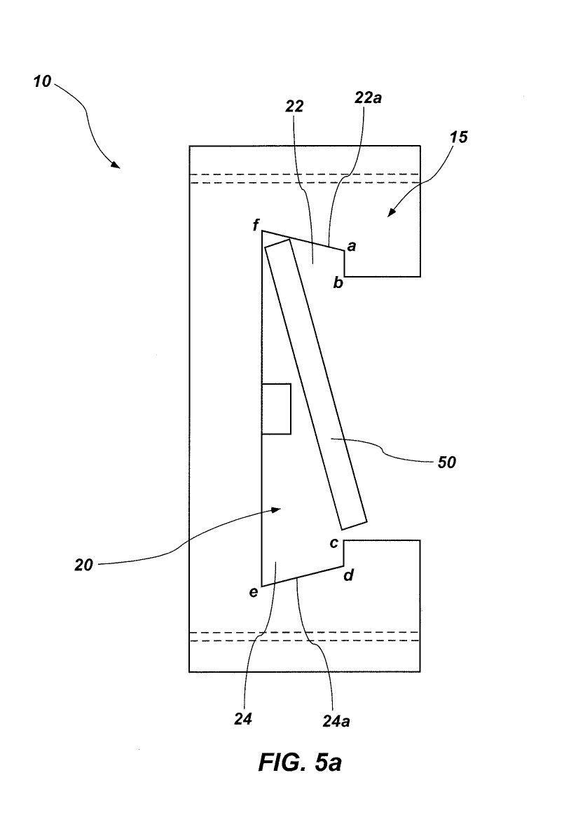

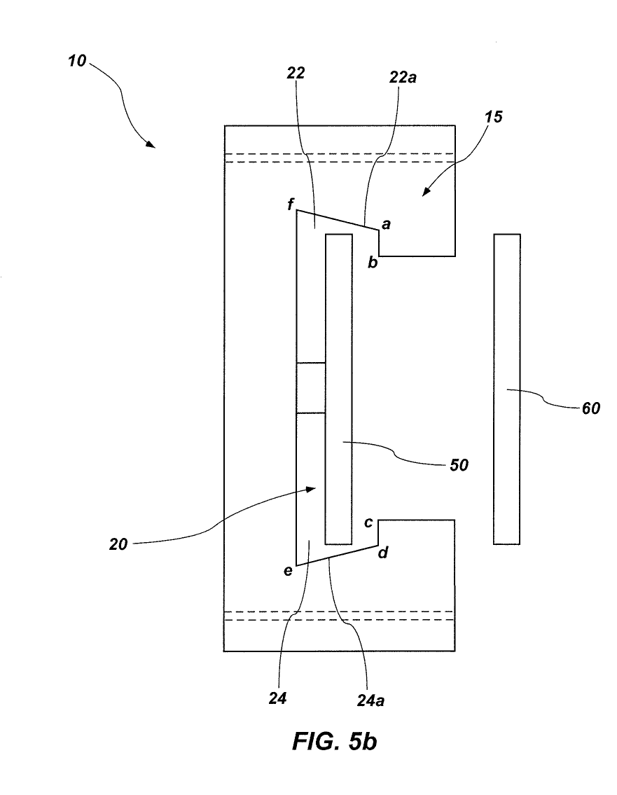

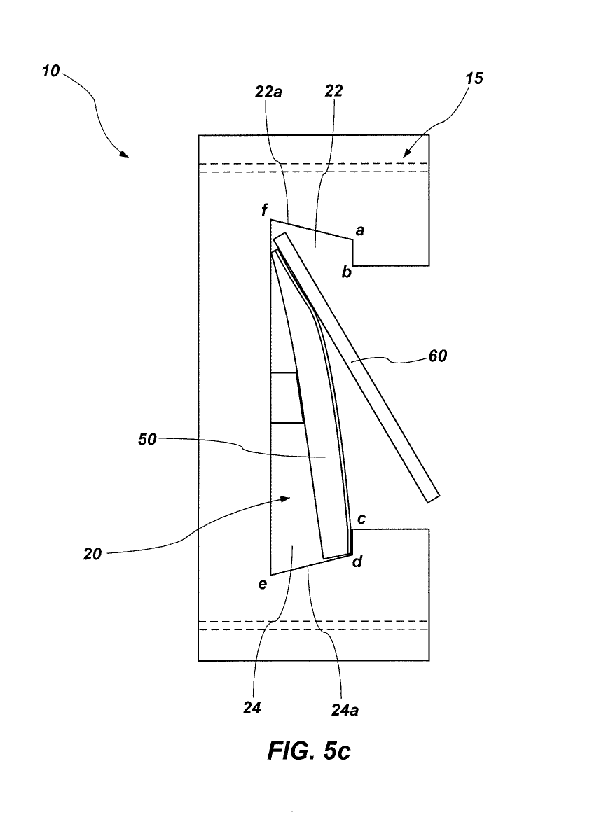

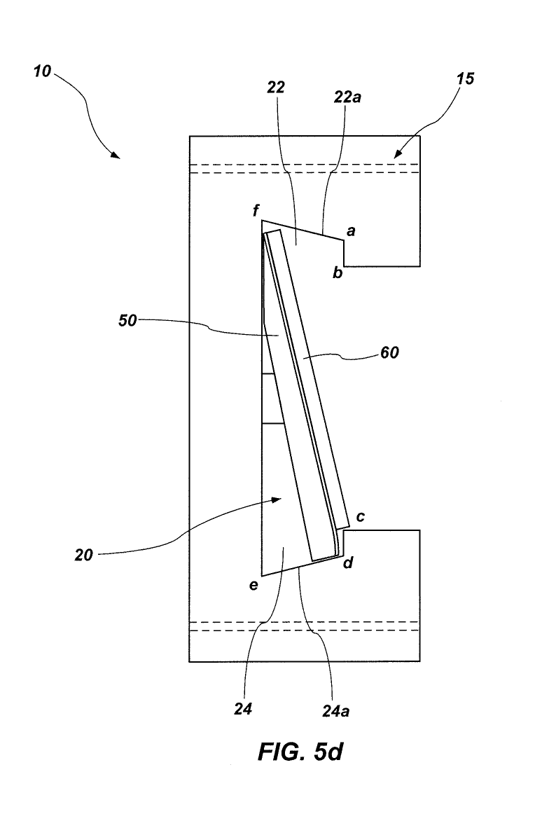

Installation of the design panel 50 and the front panel 60 is shown in FIGS. 5a through 5e. During installation of the design panel 50, a first edge of the design panel 50 may be inserted into either the top recess 22 or the bottom recess 24 and towards the back wall 25. Referring to FIG. 5a, as an edge of the design panel 50 approaches either corner for corner e of the back wall 25, enough space may be created such that the other edge of the design panel 50 may clear either corner b or corner c of the retaining ledges. Once the design panel 50 has cleared the retaining ledges of the display cavity 20, the design panel 50 may be set within the recesses of the cavity, as shown in FIG. 5b. Referring to FIG. 5c, in some embodiments, when the front panel 60 is placed into the display cavity 20, the design panel 50 may be caused to compress, creating clearance for the front panel 60 to be installed. Referring to FIG. 5d, as the front panel 60 is inserted into the display cavity 20, the compressible material 30 and the design panel 50 may be compressed towards the back wall 25 to create clearance for installation of the front panel 60. Referring to FIG. 5e, after the edges of the front panel 60 clear the retaining ledges of the display cavity 20, the front panel 60 may be disposed within the top recess 22 and the bottom recess 24. Thus, the design panel 50 and the front panel 60 may be installed without sliding such members into the body member 15 by installing such panels from a front face of the body member 15. The compressible material 30 may force the design panel 50 and the front panel 60 towards the retaining ledges and may secure such panels in place within the display cavity 20.

After the design panel 50 and the front panel 60 are installed, the compressible material 30 may expand. During installation of the panels, the compressible material 30 may be compressed to create enough clearance to install the panels within the display cavity 20. After the panels are installed, the compressible material 30 may no longer be under pressure, and the compressible material 30 may expand. The expansion of the compressible material 30 may cause the compressible material 30 to push against the back portion of the design panel 50 and may force the panel adjacent the top retaining ledge 26 and the bottom retaining ledge 28 to abut the retaining ledges. Thus, the compressible material 30 may exert a forward pressure on the design panel 50 and the front panel 60 and may cause the panels to abut the retaining ledges of the display cavity 20. In addition, the compressible material 30 may allow the interchangeable panels to remain secured in place within the body member 15 without additional members, such as retaining clips or other retaining means that may wear out or break with use. Although FIGS. 5a through 5e show installation of only the design panel 50 and the front panel 60, a molding 10 including any combination of a front panel 60, design panel 50, lighting panel 90, and back panel 80 would include substantially similar steps for installation of the lighting panel 90 and the back panel 80.

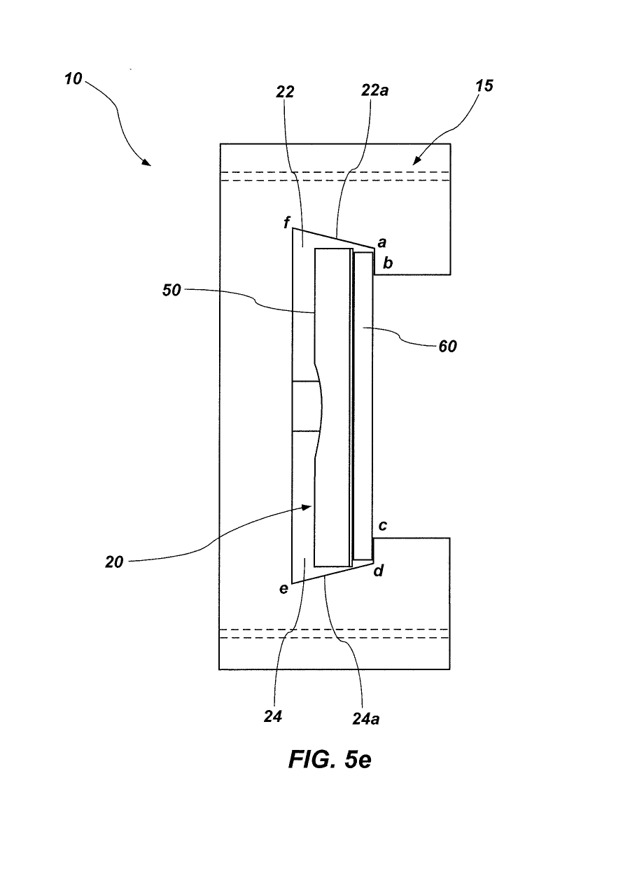

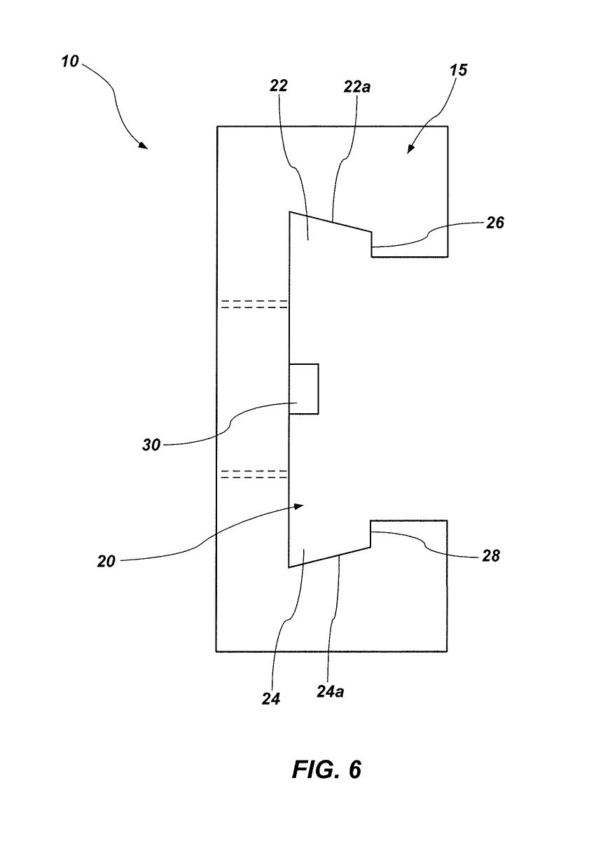

Referring to FIG. 6, the body member 15 may be designed where the top surface 22a and the bottom surface 24a are not the same length. In such an embodiment, the top retaining ledge 26 and the bottom retaining ledge 28 may have different lengths. For example, the top retaining ledge 26 may be shorter than the bottom retaining ledge 28 and the top surface 22a may be shorter than the bottom surface 24a, as depicted in FIG. 6. Alternatively, the bottom surface 24a may be longer than the top surface 22a and the bottom retaining ledge 28 may be longer than the top retaining ledge 26.

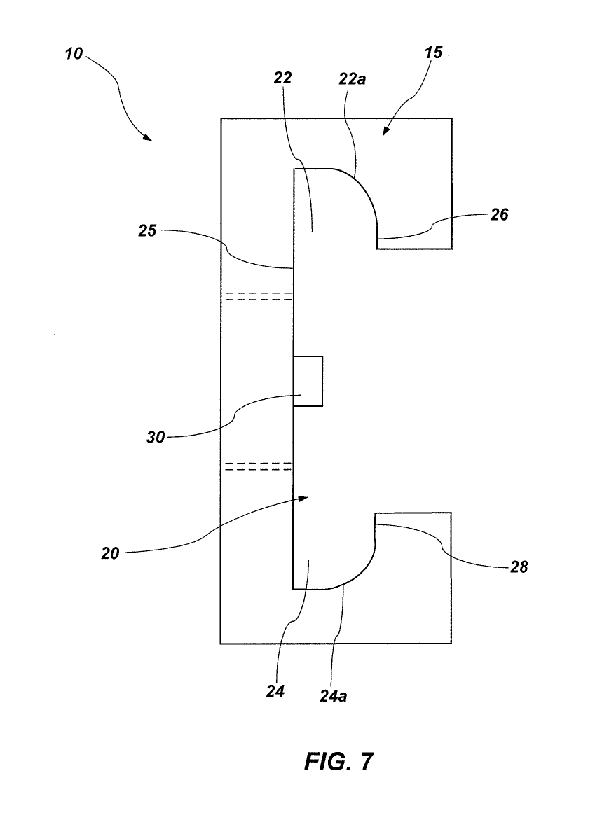

Referring to FIG. 7, in another embodiment, at least one of the top surface 22a and the bottom surface 24a may be a rounded surface. Thus, the top recess 22 may be defined by a top portion of the back wall 25, a rounded top surface 22a, and the top retaining ledge 26. The bottom recess 24 may be defined by a bottom portion of the back wall 25, a rounded bottom surface 24a, and the bottom retaining ledge 28.

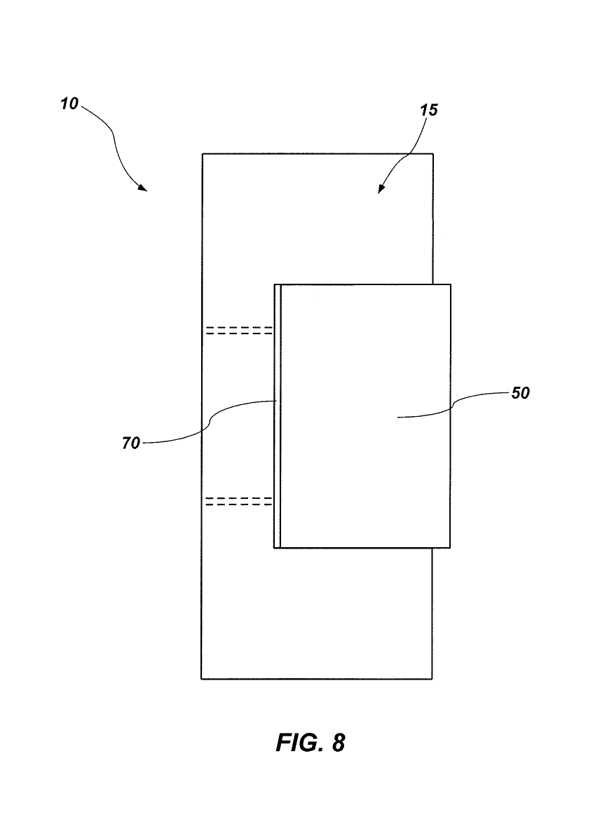

Referring to FIG. 8, the back wall 25 of the body member 15 may include an adhesive material 70 such as a double-sided tape or a glue material. In such an embodiment, the display cavity 20 may be defined by a rectangular or square shape. The design panel 50 may be secured in place by the adhesive material 70 on the back wall 25. The design panel 50 may also include the adhesive material 70 on the side adjacent the back wall 25. The adhesive material 70 may include several layers, such as when the adhesive material 70 is a double-sided tape material. In such an embodiment, the design panel 50 may extend beyond the foremost surface of the body member 15.

A molding 10 with interchangeable panels is disclosed. After the molding 10 is attached to a support structure, interchangeable panels may be interchangeably removed and installed without detaching the molding 10 from the support structure. The molding 10 may not include support clips or clamps, but may retain the interchangeable panels in place by pressing the panels against retaining ledges.

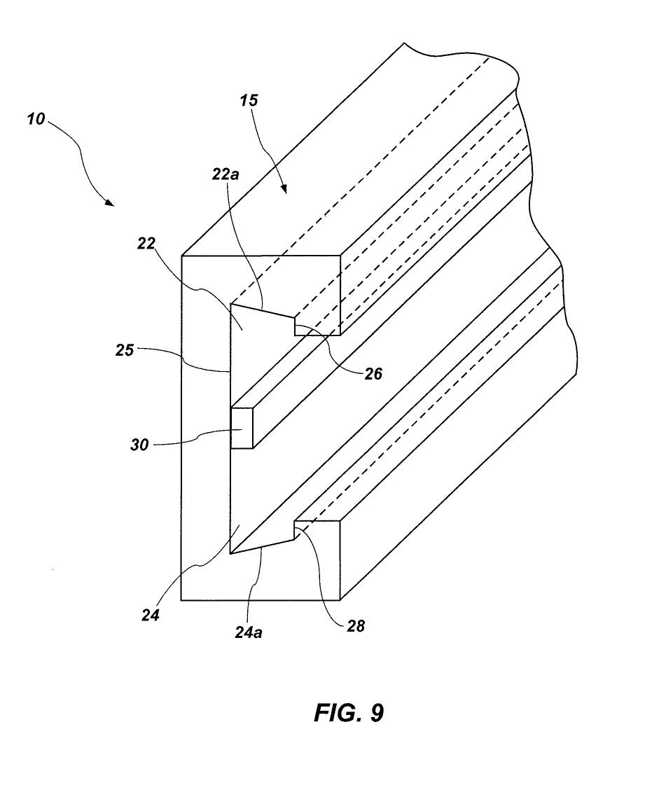

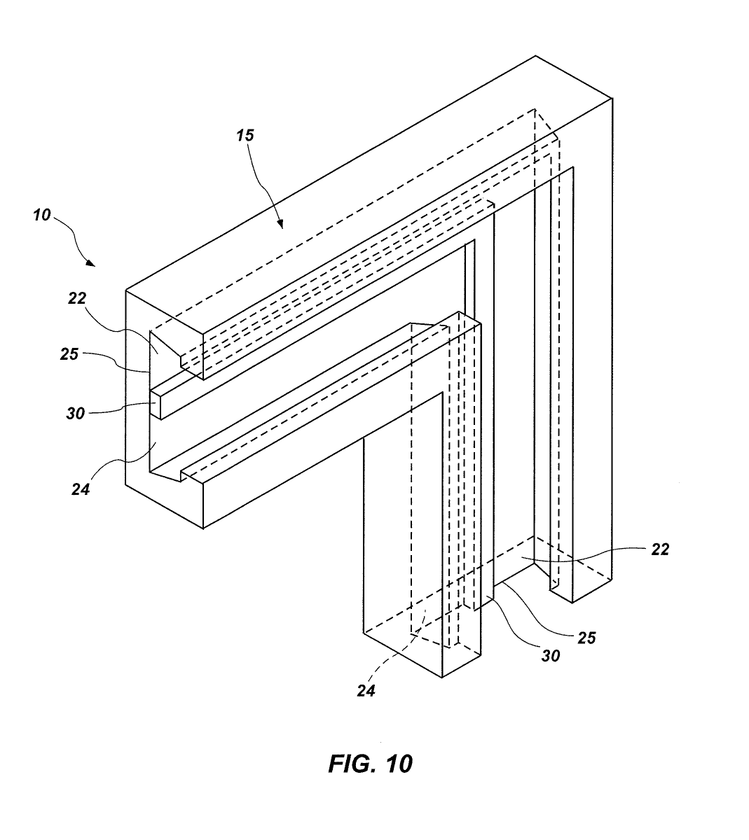

The molding 10 may be installed around various forms of intersections and corners. Referring to FIG. 9, the molding 10 may include a substantially continuous elongated member. Where pieces of molding 10 abut, the design panel 50 and/or front panel 60 may be substantially continuous and uninterrupted throughout the length of the members of molding 10 along a wall or other structure. Thus, at joints where adjacent pieces of molding 10 abut, a cap or other material may not be required to cover the intersection of adjacent pieces of molding 10 because the design panel 50, the front panel 60, and/or the lighting panel 90 may be substantially continuous across several members of molding 10. By way of non-limiting example, the design panel 50 may include a continuous fabric material that may remain continuous and uninterrupted around corners of a wall and other obstructions. Thus, the design panel 50 may be substantially continuous and uninterrupted throughout the entire room in which several members of molding 10 is installed. Referring to FIG. 10, the molding 10 may form an enclosure around a room, window, or a door structure. In such an embodiment, the design panel 50 material may be substantially continuous around corners of adjacent molding 10 members, creating the appearance of a continuous molding 10 member. The design of the display cavity 20 within the body member 15 allows the panels described herein to be interchangeably installed from the body member 15, even in embodiments where the molding 10 forms an enclosure, as shown in FIG. 10.

Although the foregoing description contains many specifics, these are not to be construed as limiting the scope of the present invention, but merely as providing certain embodiments. Similarly, other embodiments of the invention may be devised which do not depart from the scope of the present invention. For example, features described herein with reference to one embodiment also may be provided in others of the embodiments described herein. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

What is claimed is:

1. A molding member, comprising:
a body member adapted to be attached to a structure;
a removable design panel at least partially disposed within the body member, wherein the removable design panel is interchangeable after the body member is attached to the structure to which it is adapted to be attached; and
at least one removable lighting panel disposed within the body member.

2. The molding member of claim 1, wherein the at least one removable lighting panel attached to the body member comprises at least one light-emitting diode.

3. The molding member of claim 1, wherein the at least one removable lighting panel comprises at least one of a ribbon of lighting elements, a strip of lighting elements, a bar of lighting elements, and a panel of lighting elements.

4. The molding member of claim 1, wherein the at least one removable lighting panel is adapted and configured to be attached to a primary power supply and a redundant power supply.

5. The molding member of claim 1, wherein the at least one removable lighting panel is affixed to the removable design panel.

6. The molding member of claim 1, wherein the body member comprises a display cavity, the display cavity defined by a back surface, a top surface, a bottom surface, a top retaining ledge, and a bottom retaining ledge.

7. The molding member of claim 1, wherein the at least one lighting panel comprises a motion sensor switch.

8. The molding member of claim 1, wherein the at least one lighting panel comprises a dimmer switch.

9. A molding member, comprising:
a body member adapted to be attached to a structure, the body member partially enclosing a cavity, a cross-section of the cavity defined by a trapezoidal shape; and
at least one removable lighting panel at least partially disposed within the cavity, the at least one removable lighting panel being interchangeable from within the cavity after the body member is attached to the structure to which the body member is adapted to be attached to.

10. The molding member of claim 9, further comprising at least one transparent material adjacent to the at least one removable lighting panel.

11. The molding member of claim 9, further comprising a compressible material attached to a back surface, the back surface partially defining the trapezoidal shaped cavity.

12. The molding member of claim 9, further comprising at least one removable design insert at least partially disposed within the cavity.

13. The molding member of claim 12, wherein the at least one removable design insert comprises a glow in the dark material.

14. A molding member with interchangeable lighting panels, comprising:
a body member defining a cavity, the cavity being defined by:
a top surface;
a top retaining ledge and a bottom retaining ledge;
a bottom surface; and
a back surface;
at least one removable design panel at least partially disposed between the top surface and the bottom surface; and
at least one lighting panel at least partially disposed between the top surface and the bottom surface.

15. The molding member of claim 14, wherein the at least one removable design panel is disposed between the back surface and the at least one lighting panel.

16. The molding member of claim 14, wherein the at least one removable design panel comprises at least one of glass, stained glass, colored glass, and glass tile.

17. The molding member of claim 14, wherein the at least one lighting panel comprises a plurality of lighting panels electrically connected in series.

18. The molding member of claim 14, wherein the at least one lighting panel is adapted and configured to communicate with a remote controller.

19. The molding member of claim 14, wherein the at least one lighting panel is adjacent to the at least one removable design panel.

20. The molding member of claim 14, wherein the at least one lighting panel is secured to the at least one removable design panel.
